(19) United States
(12) Patent Application Publication
(10) Pub. No.: US 2023/0159129 A1
(43) Pub. Date: May 25, 2023

(54) VEHICLE

(71) Applicant: GEOPARAGON TRADE LIMITED, Sheung Wan, Hong Kong (CN)

(72) Inventor: Thomas RATH, Leibnitz (AT)

(73) Assignee: GEOPARAGON TRADE LIMITED, Sheung Wan, Hong Kong (CN)

(21) Appl. No.: 17/919,682

(22) PCT Filed: Dec. 3, 2021
(86) PCT No.: PCT/CN2021/135351

§ 371 Date: Oct. 18, 2022

(30) Foreign Application Priority Data
Dec. 7, 2020 (AT) A51062/2020

(51) Int. Cl. B62K 5/05; B62J 1/08; B62M 6/40

(52) U.S. Cl. CPC B62K 5/05; B62J 1/08; B62M 6/40; B62K 2204/00; B62J 2001/085

(57) ABSTRACT

A vehicle, in particular bicycle, with a frame, a handlebar connected to the frame rotatably about a steering axis, two front wheels and a rear wheel. In order to achieve a particularly pleasant driving behavior, the front wheels are rotatably mounted in front wheel hearings rigidly connected to the frame about front wheel axles, the rear wheel being mounted rotatably about a rear wheel axle in at least one rear wheel bearing, wherein at least one rear wheel bearing is rigidly connected to a swing arm which is pivotably connected to the frame about an articulation axis, the handlebar being coupled to the swing arm in this way that a movement of the handlebar about the steering axis causes an opposite movement of the swing arm about the articulation axis.

### TECHNICAL FIELD

The invention relates to a vehicle, in particular a bicycle, with a frame, a handlebar rotatably connected to the frame about a steering axis, two front wheels and a rear wheel.

### BACKGROUND ART

Vehicles of the type mentioned above, so-called cargo bikes, which are designed as bicycles, have become known from the prior art, in order to usually transport loads by bicycle on a loading area between the front wheels.

### SUMMARY OF INVENTION

### Technical Problem

Such bicycles are known, for example, from the documents DE 20 2015 007 267 U1 and DE 20 2017 006 957 U1.

A disadvantage of such prior art bicycles is that only a very unnatural driving experience can be achieved. Steering is often perceived as coarse and unnatural and bicycles of this type tend to tip over when turned, which is why bicycles of this type are only suitable for experienced drivers on the one hand and not suitable for sporty driving on the other hand.

### Solution to Problem

### Technical Solution

This is where the invention comes in. The object of the invention is to specify a vehicle of the type mentioned at the beginning with which an improved driving experience can be achieved.

This object is achieved according to the invention by a vehicle of the type mentioned at the outset, in which the front wheels are rotatably mounted about front wheel axles in front wheel bearings rigidly connected to the frame, the rear wheel being rotatably mounted about a rear wheel axle in at least one rear wheel bearing, wherein at least one rear wheel bearing is rigidly connected to a rocker arm which is pivotably connected to the frame about an articulated axis, the handlebar being coupled to the rocker arm in such a way that a movement of the handlebar around the steering axis causes an opposite movement of the rocker arm around the articulation axis.

In the context of the invention, it was recognized that by steering the rear wheel relative to the frame by means of a rocker arm which is pivotably connected to the frame via an articulated axis, that is to say by means of an articulated steering, a significantly improved driving experience can be achieved. Steering is still possible by means of a conventional handlebar arranged in front of a saddle of the vehicle, especially the handlebar can easily be coupled to the rocker arm, which usually extends from the articulated axis backwards to the rear wheel axis, so that a steering movement of the handlebar causes an opposite movement of the rocker arm, so that despite the articulation of the rear wheel, a steering movement on the handlebars leads to a steering behavior that corresponds to a conventional bicycle. As a result, the vehicle according to the invention is easy to handle even for inexperienced users. A corresponding coupling is purely mechanical, for example by means of a gear, or else electromechanically possible.

### Advantageous Effects of Invention

### Advantageous Effects

It is favorable if the articulation axis is oriented at an angle of less than 90 degrees to a direction of travel, in particular at an angle of 60 degrees to 89 degrees, preferably 75 degrees to 85 degrees. When the vehicle is positioned on a horizontal surface as intended, the rear wheel moves not only in a horizontal plane relative to the frame when the steering is turned, but also executes a vertical movement due to the inclination of the articulation axis. The articulation axis usually lies in a center plane of the frame that is normal to the rear axis.

If the articulation axis is oriented at an angle of less than 90 degrees to the direction of travel, every steering movement based on driving straight ahead leads to the frame, and thus a driver of the vehicle and possibly luggage connected to the frame, being lifted, namely via the rear wheel, which is moved vertically relative to the articulation axis during a steering movement. A minimum of potential energy is therefore present only when driving straight ahead, especially in this position the rear wheel axle has at a maximum distance from the articulation axis and the frame in the vertical direction.

A deflection based on driving straight ahead in any direction thus leads to a restoring torque acting on the rocker arm and thus also on the handlebar with a correspondingly arranged articulation axis. This restoring torque leads to a position of minimum energy or a position of the rocker arm relative to the frame in which the rear wheel axle has a maximum vertical distance from the frame, i.e. a position of the rocker arm and frame when driving straight ahead, without counter-torque, for example through a corresponding steering movement by the driver. In other words, when the handlebar is released, the vehicle automatically returns to driving straight ahead, making it very easy and natural to handle.

The vehicle is preferably designed in such a way that a center of gravity of the load is as close as possible to the handlebar in order to be able to make maximum use of a articulating effect. In a plan view, the loading area can therefore extend both as far as the handlebars and around the handlebars.

Usually it is provided that the front wheels are arranged symmetrically in relative to a center plane of the vehicle. A plane which is normal to the rear wheel axis and in which the articulation axis and a steering axis are usually located, is referred to here as the center plane. A correspondingly symmetrical arrangement of the front wheels results in an even load distribution on the one hand and a pleasant driving experience on the other hand in a structurally simple manner.

The front wheel axles are usually arranged at approximately the same length position and are normally oriented approximately normal to the direction of travel. The front wheel axles preferably intersect in the area of the central plane, wherein the front wheel axles can also be coaxial or coincide. Of course, the front wheels can also have a camber.

The front wheels are usually designed with the same size and can have a radius corresponding to the rear wheel, but can also be designed larger or smaller than the rear wheel.

It is preferably provided that a loading area is arranged between the front wheels. The loading area is usually rigidly connected to the frame. It can also be provided that the front wheel bearings, via which the front wheels are rotatably connected to the frame about the front wheel axles, are arranged in connecting elements protruding from the loading area, so that the loading area can be lower than the front wheel axles.

It is favorable if the handlebar is connected to the rocker arm via a mechanism which has a linkage attached to the rocker arm on the one hand and to the handlebar on the other hand in opposite directions. This enables a particularly simple construction to achieve an opposing movement of the rocker arm on the one hand and the handlebar on the other hand relative to the frame. The rocker arm then moves, for example, counterclockwise in a plan view relative to the frame when the handlebar is moved clockwise in a plan view. The linkage, which usually intersects the center plane, can in principle be connected to both the handlebar and the rocker arm in any position, although it is preferably provided that the linkage is connected with the handlebar near to the steering axis and is connected with the rocker arm near to the articulation axis.

In order to achieve a particularly favorable driving experience, it is preferably provided that the linkage is rotatably connected on the one hand to the handlebar via a first lever and on the other hand to the rocker arm via a second lever, wherein a length of the first lever in a plane normal to a first linkage axis , about which the linkage is rotatably connected to the first lever, corresponds to 0.5 times to 2 times a length of the second lever in this plane. The linkage can also be formed by just a single rigid lever which intersects normally the center plane between the handlebar and the rocker arm.

A length of the first lever preferably corresponds approximately to a length of the second lever in a plane normal to a first linkage axis. A first linkage axis around which the linkage is rotatably connected to the first lever, is usually normal to an imaginary connecting line passing through a point at which the linkage is connected to the first lever and a point at which the linkage is connected to the second lever. For example, the first linkage axis can be approximately parallel to the articulation axis or to the steering axis. A second linkage axis, around which the linkage is connected to the second lever, can be parallel to the first linkage axis in order to ensure the simplest possible actuation. For example, it can be provided that the first linkage axis and the second linkage axis are oriented parallel and approximately vertically when the vehicle is positioned as intended on a flat surface.

A particularly stable driving behavior can be achieved if a double linkage is provided, a second linkage being arranged above a first linkage, the first linkage and second linkage intersecting or rossing one another in a plan view. Usually, a linkage is then subjected to tension and a linkage to pressure with each steering movement, which results in a uniform response behavior.

The individual linkages are rotatably connected to the handlebar and the rocker arm usually again via levers. In the case of a double linkage, the linkages are usually arranged on both sides of the handlebar, whereby, for example, an upper linkage can be positioned on the left and a lower linkage on the right of the handlebar, so that several levers are arranged on the handlebar, wherein the levers protrude in different directions away from a handlebar axis. Instead of or in addition to the arrangement of several levers, a turntable can also be positioned on the handlebar, wherein both the upper linkage and the lower linkage are rotatably connected to the turntable, for example rotatably connected about an approximately vertical axis, so that the first lever for both the upper linkage and for the lower linkage is formed by the turntable.

The vehicle according to the invention can be designed as a vehicle driven entirely without muscle power, for example as a motorcycle or electric scooter. An actuation can take place, for example, via a handle on the handlebar, so similar to an actuation of a motorcycle by means of a throttle grip. The vehicle can then be driven without pedaling.

In principle, the vehicle according to the invention can be driven in any desired manner, that is to say also by an internal combustion engine, an electric motor and/or a combination of different drive concepts or as a hybrid vehicle. Of course, a drive through a combination of an electric and/or internal combustion engine drive with a drive using muscle power is also possible, so that, for example, both a force applied via pedals and a force applied by a motor act on the wheels.

In one embodiment, the vehicle can be designed as a bicycle, so that it is driven exclusively by or at least under the action of muscle power, which is applied, for example, via pedals, so that locomotion is also possible regardless of a fill level of an energy storage device such as an accumulator or a fuel tank.

A vehicle according to the invention preferably has pedals for a drive, wherein the pedals can be connected to the front wheels and/or the rear wheel via a bicycle chain or the like. It is preferably provided that the vehicle is designed as an electric bicycle. In this case, the front wheels and/or the rear wheel can be driven electrically, with an accumulator being arranged, for example, between the front wheels and/or in the frame. In this case, the vehicle can be driven both by muscle power and in parallel or alternatively by one or more electric motors.

It is in particular preferably provided that a saddle can be rigidly connected to the frame in different vertical positions, the rear wheel being pivotable about the articulation axis relative to the saddle by means of the rocker arm. For example, for this purpose the frame can have a seat tube in which a seat post can be fastened at different positions, for example by means of a clamp. A longitudinal axis of the seat tube usually lies in the center plane.

It has been proven that a saddle receptacle for receiving a saddle is arranged between the handlebar and the rear wheel axle, in particular between that of the articulated axis and the rear wheel axis, although an arrangement of the saddle in front of the articulated axis is also possible. In a vehicle according to the invention, the saddle is usually located approximately in the middle between the rear wheel axle and the articulated axle. The saddle receptacle can be formed by a saddle tube.

The handlebar is usually located in a plan view between the saddle and the front wheel axles.

The rocker arm of a vehicle according to the invention can in principle have the most varied of lengths. In order to achieve a particularly pleasant driving experience, it has been proven that a distance between the rear wheel axle and the articulated axle corresponds to at least one radius of the rear wheel, preferably 1.05 times to 1.3 times the radius of the rear wheel.

The rocker arm can be made in one piece or in several pieces. If the rocker arm is made in one piece, a distance between the rear wheel axle and the articulation axis corresponds essentially to a length of the rocker arm.

### BRIEF DESCRIPTION OF DRAWINGS

### Description of Drawings

Further features, advantages and effects of the invention emerge from the exemplary embodiment shown below. In the drawings to which reference is made:

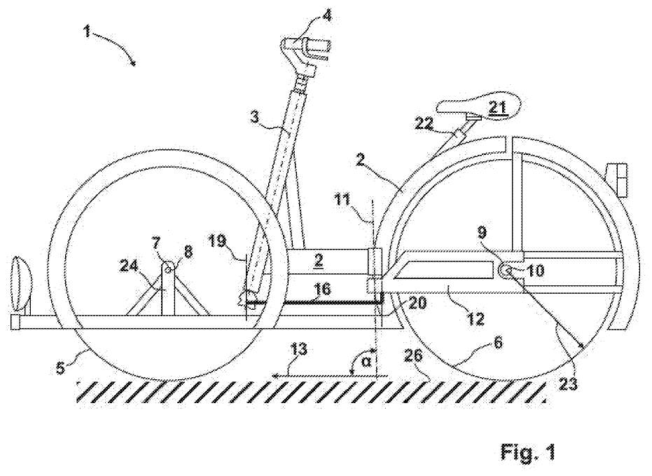

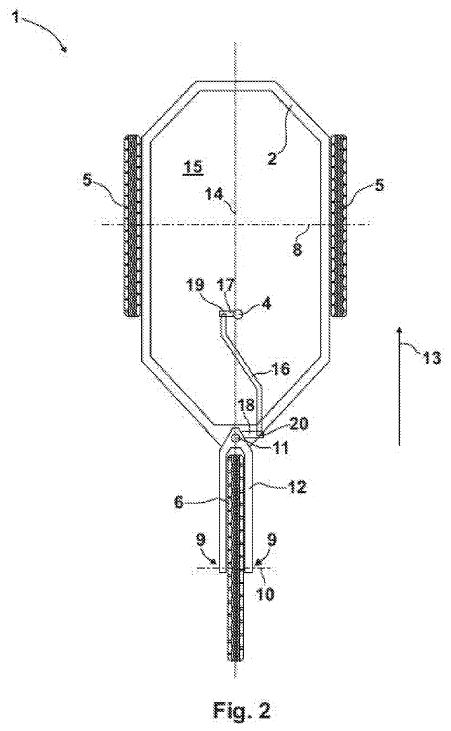

FIGS. 1 and 2 show a vehicle according to the invention in different views;

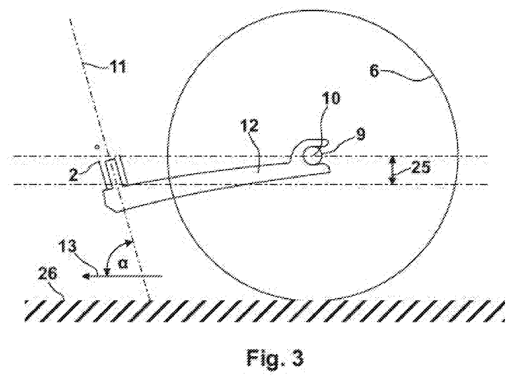

FIG. 3 shows a detail of a vehicle according to the invention.

### BEST MODE FOR CARRYING OUT THE INVENTION

### Best Mode

Input the paragraph which describes the best mode here.

### Mode for the Invention

### Mode for Invention

FIG. 1 shows a vehicle according to the invention, which is designed as a bicycle 1, in a side view. As can be seen, the bicycle 1 has a frame 2 and a handlebar 4 connected to the frame 2 rotatably about a steering axis 3 and a saddle 21 detachably and rigidly connected to the frame 2, which saddle 21 can be attached at different positions relative to the frame 2, namely here by means of a saddle tube 22. The bicycle 1 also has a rear wheel 6 and two front wheels 5, via which the bicycle 1 is supported against a floor and with which the bicycle 1 can be moved along a direction of travel 13.

The front wheels 5 are mounted rotatably about front wheel axles 8, which are coaxial, in front wheel bearings 7, which front wheel bearings 7 are rigidly connected to the frame 2 and thus also to the saddle 21, namely via connecting elements 24 arranged on the frame 2, which protrude from the loading area 15.

The rear wheel 6 is mounted rotatably around a rear wheel axle 10 in rear wheel bearings 9, which rear wheel bearings 9 are not arranged in the frame 2 itself, as in a conventional bicycle 1, but in a rocker arm 12, which rocker arm 12 can be pivoted or rotated about the articulated axis 11 and is connected to the frame 2 and extends from frame 2 against the direction of travel 13 or backwards to the rear wheel axle 10.

In contrast to a conventional bicycle 1, the front wheel 5 is not rotatably connected to the frame 2 or the saddle 21 about a vertical or approximately vertical axis, but the rear wheel 6. For an actuation corresponding to a conventional bicycle 1, however, the handlebar 4 is connected to the rocker arm 12 via a linkage 16, so that a movement of the handlebar 4 causes the rocker arm 12 to move in opposite directions. Thus, for example, a clockwise movement of the handlebar 4 about the steering axis 3 causes the rocker arm 12 to move counterclockwise about the articulated axis 11. This brings about a reaction to a steering movement on the handlebar 4 corresponding to a conventional bicycle 1, which makes the bicycle 1 easy to handle.

FIG. 2 shows this linkage 16 in detail, wherein FIG. 2 shows a plan view of a bicycle 1 according to the invention. In order to be able to recognize the steering linkage particularly well, the handlebars 4 and the saddle 21 are not shown here particularly.

As can be seen, the handlebar 4, which is connected to the frame 2 rotatably about a steering axis 3, has a first lever 17 in one area, which is rigidly connected to the handlebar 4. The linkage 16 is connected to this first lever 17 rotatably about a first linkage axis 19 on the one hand. On the other hand, the linkage 16 is connected to a second lever 18 rotatably about a second linkage axis 20, which second lever 18 is in turn rigidly connected to the rocker arm 12.

In the view shown, the linkage 16 is connected to the first lever 17 on a left side of the central plane 14 viewed in the direction of travel 13 and to the rocker arm 12 on a right side of the central plane 14, so that there is a correspondingly opposite movement of the rocker arm 12 relative to the movement of the handlebar 4. The first linkage axis 19 and the second linkage axis 20 are oriented here approximately parallel and vertically or normal to a plane of a ground 26, which plane is defined, for example, by the rear wheel axis 10 and the direction of travel 13. The linkage 16, which is formed here by a single inherently rigid component, thus intersects the center plane 14 between the steering axis 3 and the articulation axis 11, as shown.

A steering behavior can in particular be influenced by the length of the first lever 17 and the second lever 18 or by a ratio of the lengths of the two levers 17, 18, wherein a length of the first lever 17 roughly corresponds to a length of the second lever 18 in the illustrated embodiment.

As can be seen in FIG. 1 and FIG. 2, the front wheels 5 of the bicycle 1 designed as a cargo bike are horizontally spaced from one another, so that there is sufficient space between them for a loading area 15 on which, for example, luggage can be arranged.

As shown, the rocker arm 12 has a length from the articulation axis 11 to the rear wheel axis 10, which is slightly larger than a radius 23 of the rear wheel 6, so that good mobility of the rear wheel 6 relative to the frame 2 is ensured.

Furthermore, it can be clearly seen in FIG. 2 that the rocker arm 12 extends on both sides of the rear wheel 6, so that the rear wheel 6 is supported on both sides or symmetrically in rear wheel bearings 9 fastened in the rocker arm 12, although only one-sided support is also possible.

FIG. 3 shows a detail of a bicycle 1 according to the invention, which brings about a particularly pleasant driving behavior, namely a part of the frame 2, to which the rocker arm 12 is connected pivotably about an articulated axis 11, the rocker arm 12 and the rear wheel 6 including the rear wheel bearing 9. Furthermore a ground 26 is shown on which the bicycle 1 is positioned.

As can be seen particularly clearly here, the articulation axis 11, which is generally in the central plane 14 or parallel thereto, is deflected from a vertical or oriented at an angle a of less than 90 degrees in relative to the direction of travel 13. This also results in a vertical movement of the rear wheel 6 relative to the frame 2 during a steering movement, which vertical movement causes the frame 2 and a driver possibly sitting on the saddle 21 to be raised or lowered by a height difference 25 shown schematically in FIG. 3.

An energy minimum in terms of potential energy is achieved when the rocker arm 12 is oriented exactly backwards or against the direction of travel 13, as shown in FIG. 3, especially the frame 2 supported by the articulated axle 11 and the rear wheel 6 and the front wheels 5 is then at the lowest possible position, which is indicated here by a lower horizontal dash-dotted line. Each deflection from this position thus leads to a lifting of the driver or a lifting of a weight connected to the frame 2 up to a highest maximum position, which is indicated here schematically by an upper dash-dotted line. A distance between the lowest possible position and the highest possible position is referred to here as a height difference 25.

As a result of this lifting of the frame 2 over the rocker arm 12, a restoring torque acts on the rocker arm 12 about the articulation axis 11 in the event of a deflection from driving straight ahead, wherein the restoring torque causes the rocker arm 12 to move back into the position shown in FIG. 3, if this restoring torque is not counteracted by a corresponding steering torque to maintain or increase a steering angle. As a result, the bicycle 1 is automatically steered back in the direction of driving straight ahead when the handlebar 4 is released, as well as the vehicle is comfortable to drive.

The bicycle 1 can be designed for purely manual confirmation and/or as an electric bicycle, wherein both the front wheels 5 and the rear wheel 6 are able to be driven.

Alternatively, the vehicle according to the invention can also be designed as a vehicle driven entirely without muscle power, for example as a motorcycle or electric scooter. A drive then takes place by means of an internal combustion engine and/or an electric motor, actuation preferably being made possible via a throttle grip arranged on the handlebar 4.

With a vehicle according to the invention, in particular an electric scooter, a cargo bike or a cargo bike is thus achieved, which on the one hand is simple in construction and on the other hand can be operated in a sporty manner and is pleasant to drive so that this vehicle enables loads to be transported comfortably, even for inexperienced users.

1. A vehicle, in particular bicycle, with a frame, a handlebar connected to the frame rotatably about a steering axis, two front wheels and a rear wheel, wherein the front wheels are rotatably mounted in front wheel bearings rigidly connected to the frame about front wheel axles, the rear wheel being mounted rotatably about a rear wheel axle in at least one rear wheel bearing, wherein at least one rear wheel bearing is rigidly connected to a swing arm which is pivotably connected to the frame about an articulation axis, the handlebar being coupled to the swing arm in this way that a movement of the handlebar about the steering axis causes an opposite movement of the rocker arm about the articulation axis.

2. The vehicle as claimed in claim 1, wherein the articulation axis is oriented at an angle (α) of less than 90 degrees to a direction of travel, in particular at an angle (α) of 60 degrees to 89 degrees, preferably 75 degrees to 85 degrees.

3. The vehicle as claimed in claim 1, wherein the front wheels are arranged symmetrically in relative to a center plane of the vehicle.

4. The vehicle according to claim 1, wherein a loading area is arranged between the front wheels.

5. The vehicle according to claim 1, wherein the handlebar is connected to the rocker arm via a mechanism which has a linkage attached to the rocker arm on the one hand and to the handlebar on the other hand in opposite directions.

6. The vehicle according to claim 1, wherein a linkage is rotatably connected on the one hand to the handlebar via a first lever and on the other hand to the rocker arm via a second lever, wherein a length of the first lever in a plane normal to a first linkage axis, about which the linkage is rotatably connected to the first lever, corresponds to 0.5 times to 2 times a length of the second lever in this plane.

7. The vehicle as claimed in claim 6, wherein a double linkage is provided, a second linkage being arranged above a first linkage, the first linkage and second linkage intersecting or crossing one another in a plan view.

8. The vehicle according to claim 1, wherein the vehicle is designed as an electric scooter.

9. The vehicle according to claim 1, wherein the vehicle is designed as an electric bicycle.

10. The vehicle according to claim 1, wherein a saddle can be connected to the frame in different vertical positions, the rear wheel being pivotable about the articulation axis relative to the saddle by the rocker arm.

11. The vehicle according to claim 1, wherein a saddle receptacle for receiving a saddle is arranged between the articulation axis and the rear wheel axis.

12. The vehicle according to claim 1, wherein a distance between the rear wheel axle and the articulated axle corresponds to at least one radius of the rear wheel, preferably 1.05 times to 1.3 times the radius of the rear wheel.
